(19) United States
(12) Patent Application Publication
(10) Pub. No.: US 2019/0222770 A1
(43) Pub. Date: Jul. 18, 2019

(54) IMAGE VIEWING ANGLE SWITCHING SYSTEM FOR REVERSING IMAGE DISPLAY AND METHOD THEREOF

(71) Applicants: FORTRESS AUTO INT'L LTD., Taoyuan City (TW); INVENTEC BESTA CO., LTD., Taipei (TW)

(72) Inventor: Kuo-Hui TSAI, Taoyuan City (TW)

(21) Appl. No.: 15/872,963

(22) Filed: Jan. 16, 2018

(51) Int. Cl. H04N 5/232; B60R 1/00

(52) U.S. Cl. CPC H04N 5/23296; H04N 5/23293; H04N 5/23229; B60R 2300/607; B60R 2300/105; B60R 2300/301; B60R 2300/602; B60R 1/00

(57) ABSTRACT

The present disclosure illustrates an image viewing angle switching system for reversing image display and a method thereof. In an embodiment, a reversing image is performed by image fisheye correction, image cropping processing, image white balance processing and image exposure processing to generate a horizontal-view reversing image or a top-view reversing image, and the horizontal-view reversing image is switched to the top-view reversing image for display according to a vehicle reversing distance from the vehicle to an obstruction, thereby achieving a technical effect of avoiding blind spot for the reversing image.

### BACKGROUND

### 1. Technical Field

The present disclosure relates to an image viewing angle switching system and a method thereof, more particularly to an image viewing angle switching system which is able to convert a reversing image to a horizontal-view reversing image or a top-view reversing image by performing image fisheye correction, image cropping processing, image white balance processing and image exposure processing on the reversing image, and a method thereof.

### 2. Description of Related Arts

Existing reversing image display system generally uses single image capture module to capture a reversing image which is an image at the rear of a vehicle displayed for a driver, thereby assisting the driver in reversing vehicle. However, there is still a blind spot for the reversing image captured by the single image capture module, for example, an area below the rear of the vehicle is the blind spot area for the reversing image, and it means that there is still much room for improvement in safety of existing reversing image display system.

If the single image capture module of the reversing image display system is mounted at a lower position, it decreases chances that the area below the rear of the vehicle is the blind spot area while the vehicle is reversing, but the image capture module of the reversing image display system may be blocked by an obstruction easily to fail in providing the reversing image, and it is more dangerous for the driver in reversing the vehicle.

Therefore, what is need is to improve existing reversing image display system to solve the conventional technology problem that unsafety is caused by the blind spot area.

### SUMMARY

In order to solve conventional problem that unsafety is caused by the blind spot area, the present disclosure is to provide an image viewing angle switching system for reversing image display, and the system includes a reversing image display device and an electronic device, and the reversing image display device is mounted at the rear of a vehicle. The reversing image display device includes a distance detecting module, an image capture module, an image processing module and a first wireless transmission module.

While a vehicle is reversing, the distance detecting module of the reversing image display device is activated to continuously detect a vehicle reversing distance from the vehicle to an obstruction and transmit a switching command when the vehicle reversing distance is determined to be smaller than or equal to a preset distance. While the vehicle is reversing, the image capture module of the reversing image display device is activated to continuously capture a reversing image. The reversing image is captured by a fisheye lens of the image capture module and has a first image viewing angle range. The image processing module of the reversing image display device receives the switching command from the distance detecting module and receives the reversing image from the image capture module. The image processing module is configured to perform image fisheye correction, image cropping processing, image white balance processing and image exposure processing on the reversing image to generate a horizontal-view reversing image which has a second image viewing angle range. Upon receipt of the switching command, the image processing module performs image fisheye correction, image cropping processing, image white balance processing and image exposure processing on the reversing image to generate a top-view reversing image which has a third image viewing angle range. The first wireless transmission module is configured to receive the horizontal-view reversing image from the image processing module or receive the top-view reversing image from the image processing module, and transmit the horizontal-view reversing image or the top-view reversing image by a wireless transmission manner.

The electronic device is configured to receive the horizontal-view reversing image or the top-view reversing image from the first wireless transmission module, and display the horizontal-view reversing image or the top-view reversing image.

In order to solve conventional problem that unsafety is caused by the blind spot area, the present disclosure further provides an image viewing angle switching method for reversing image display, and the method includes following steps.

First, a reversing image display device mounted at a rear of a vehicle is provided, and the reversing image display device includes a distance detecting module, an image capture module, an image processing module and a first wireless transmission module. While the vehicle is reversing, the distance detecting module is activated to continuously detect a vehicle reversing distance from the vehicle to an obstruction, and then transmits a switching command when the vehicle reversing distance is determined to be smaller than or equal to a preset distance. While the vehicle is reversing, the image capture module is activated to continuously capture a reversing image which is captured by a fisheye lens of the image capture module, and the reversing image captured by the fisheye lens has a first image viewing angle range. The reversing image is received from the image capture module, and image fisheye correction, image cropping processing, image white balance processing and image exposure processing are performed on the reversing image to generate a horizontal-view reversing image which has a second image viewing angle range. Next, when the image processing module receives the switching command from the distance detecting module, the image processing module receives the reversing image and performs image fisheye correction, image cropping processing, image white balance processing and image exposure processing on the reversing image to generate a top-view reversing image which has a third image viewing angle range. The first wireless transmission module receives the horizontal-view reversing image from the image processing module or the top-view reversing image from the image processing module, and then transmits the horizontal-view reversing image or the top-view reversing image to an electronic device by a wireless transmission manner. The electronic device displays the horizontal-view reversing image or the top-view reversing image.

To summarize, the difference between the present disclosure and the conventional technology is that the image viewing angle switching system of the present disclosure performs the image fisheye correction, the image cropping processing, the image white balance processing and the image exposure processing on the reversing image to generate the horizontal-view reversing image or the top-view reversing image, and switches between the horizontal-view reversing image and the top-view reversing image for display according to the vehicle reversing distance from the vehicle to the obstruction, thereby assisting the driver in more safely reversing the vehicle.

Therefore, by aforementioned technology means, the image viewing angle switching system and method of the present disclosure are able to achieve the technical effect of avoiding the blind spot for the reversing image.

### BRIEF DESCRIPTION OF THE DRAWINGS

The structure, operating principle and effects of the present disclosure will be described in detail by way of various embodiments which are illustrated in the accompanying drawings.

FIG. 1 is a system block diagram of an image viewing angle switching system for reversing image display, in accordance with the present disclosure.

FIG. 2A is a schematic view of a reversing image display device of the image viewing angle switching system of the present disclosure, when viewed from a first viewing angle.

FIG. 2B is a schematic view of a reversing image display device of the image viewing angle switching system of the present disclosure, when viewed from a second viewing angle.

FIG. 3A is a schematic view showing a first image viewing angle range of a reversing image of the image viewing angle switching system of the present disclosure.

FIG. 3B is a schematic view showing a second image viewing angle range of a horizontal-view reversing image of the image viewing angle switching system of the present disclosure.

FIG. 3C is a schematic view showing a third image viewing angle range of a top-view reversing image of the image viewing angle switching system of the present disclosure.

FIG. 4 is a flowchart showing the steps in an operation of the image viewing angle switching method for reversing image display, in accordance with the present disclosure.

FIG. 5A shows the horizontal-view reversing image of the image viewing angle switching system for reversing image display, in accordance with the present disclosure.

FIG. 5B shows the top-view reversing image of the image viewing angle switching system for reversing image display, in accordance with the present disclosure.

### DETAILED DESCRIPTION

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

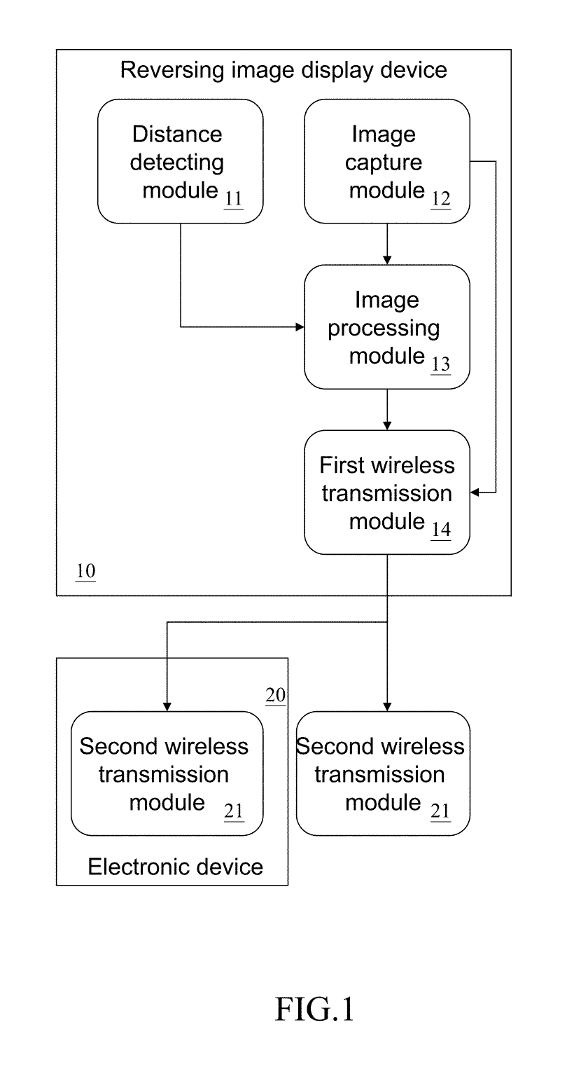

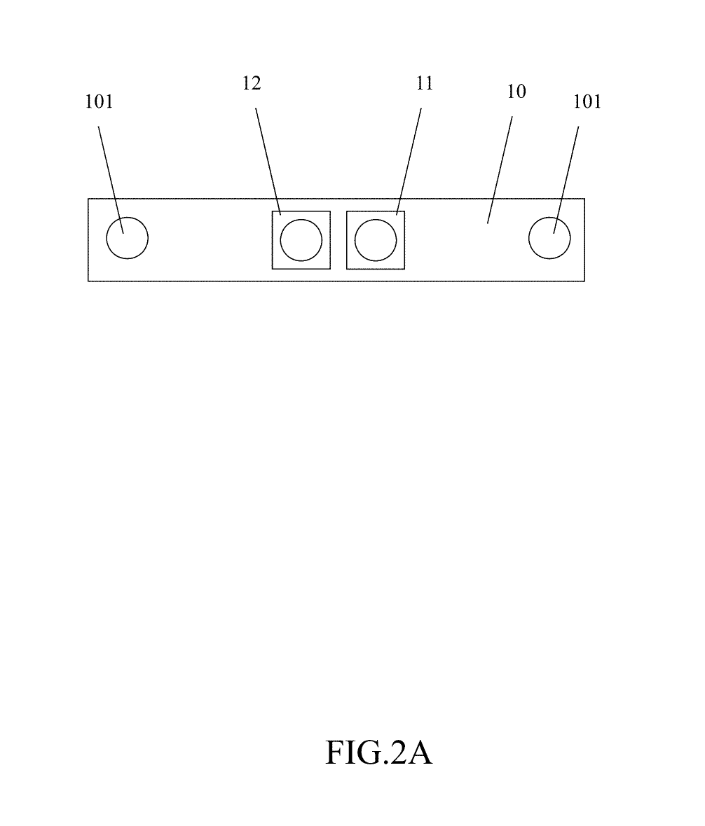

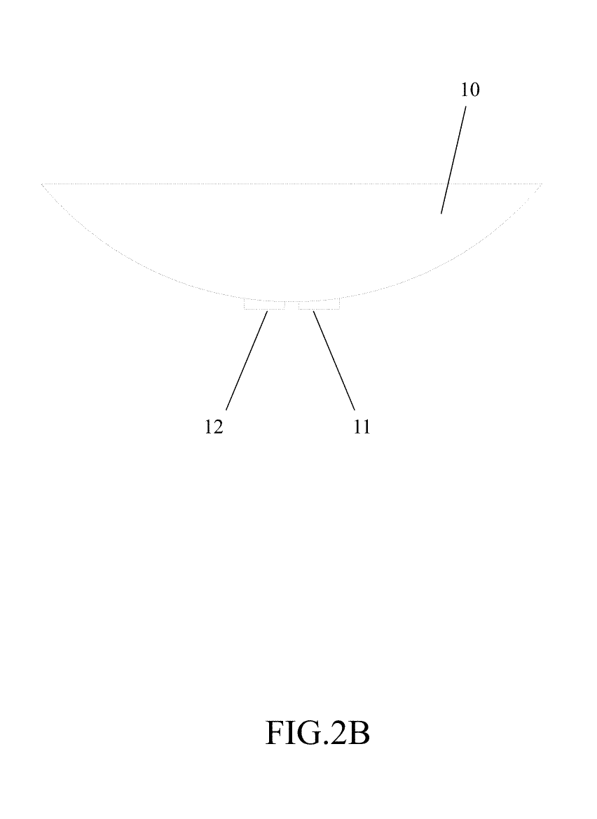

The following refers to FIG. 1, FIGS. 2A and 2B for illustration of the image viewing angle switching system for reversing image display. FIG. 1 is a system block diagram of the image viewing angle switching system of the present disclosure. FIG. 2A is a schematic view of a reversing image display device of the image viewing angle switching system of the present disclosure, when viewed from a first viewing angle; and FIG. 2B is a schematic view of the reversing image display device of the image viewing angle switching system of the present disclosure, when viewed from a second viewing angle.

The image viewing angle switching system is applied for reversing image display, and includes a reversing image display device 10 and an electronic device 20, and the reversing image display device 10 further includes a distance detecting module 11, an image capture module 12, an image processing module 13 and a first wireless transmission module 14.

The reversing image display device 10 is mounted on a rear of a vehicle by a screwing manner through screw holes 101 at left and right side of the rear. Positions of the distance detecting module 11 of the reversing image display device 10 and the image capture module 12 shown in FIG. 2A are merely for schematic illustration, but the application field of the present disclosure is not limited thereto.

While the vehicle is reversing, the distance detecting module 11 of the reversing image display device 10 is activated to continuously detect a vehicle reversing distance from the vehicle to an obstruction. Preferably, the distance detecting module 11 of the reversing image display device 10 may be implemented by an ultrasonic radar to detect the vehicle reversing distance from the vehicle to the obstruction, but the application field of the present disclosure is not limited thereto.

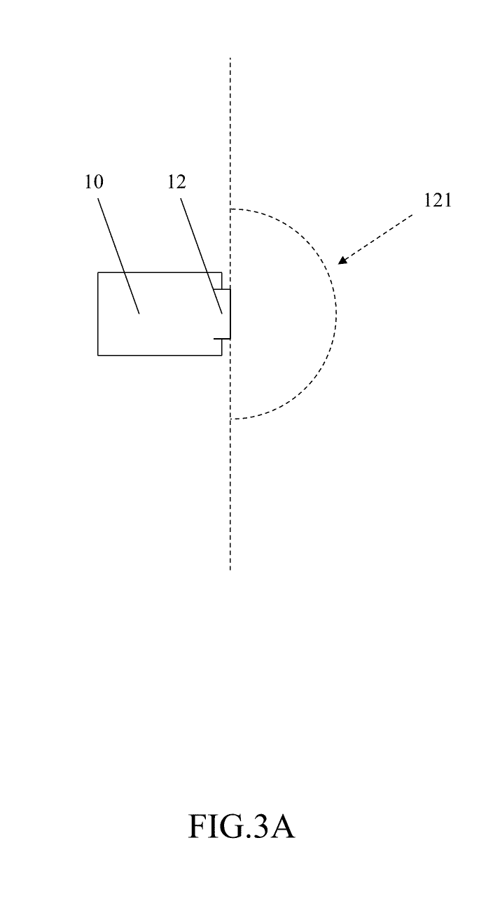

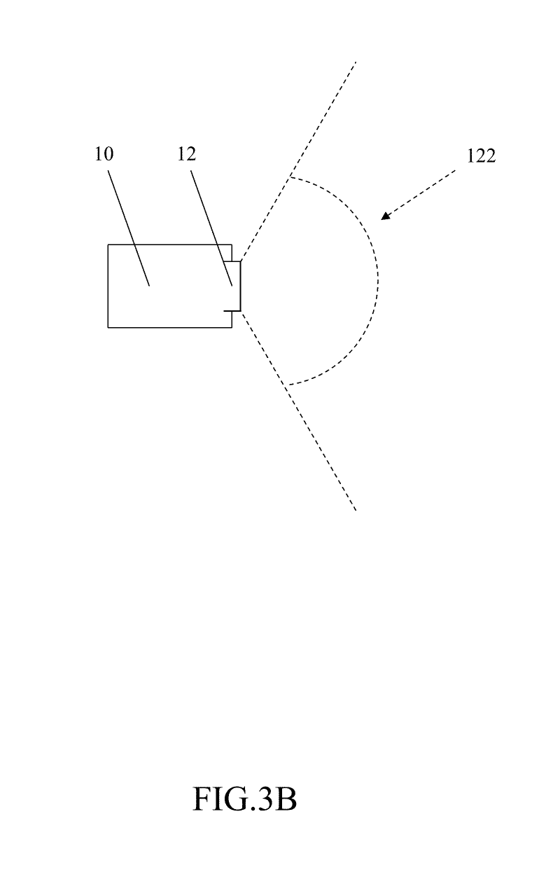

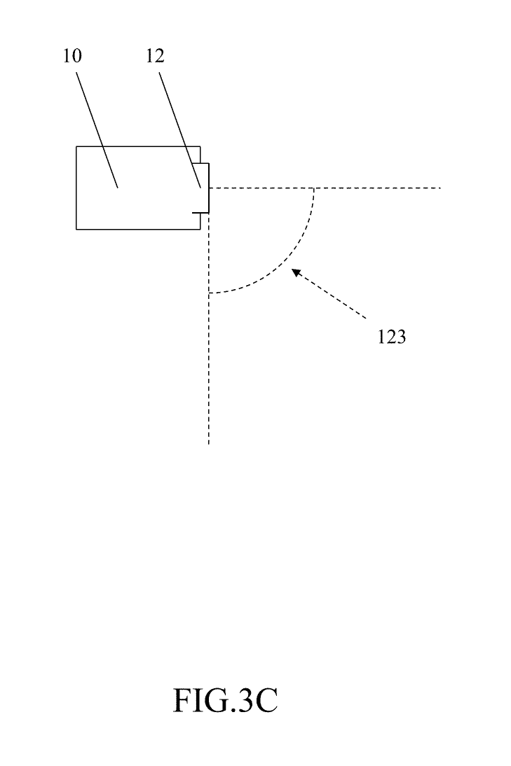

While the vehicle is reversing, the image capture module 12 of the reversing image display device 10 is activated to continuously capture the reversing image. The reversing image is captured by a fisheye lens of the image capture module 12, and the reversing image captured by the fisheye lens has a first image viewing angle range 121. The first image viewing angle range 121 of the reversing image may be adjusted upon practice demand, for example, the first image viewing angle range 121 may be in a range of from −90 degrees to 90 degrees. FIG. 3A is a schematic view of the first image viewing angle range of the reversing image of the image viewing angle switching system of the present disclosure, and shows the first image viewing angle range 121 of the reversing image; however, FIG. 3A is merely for exemplary illustration, and the application field of the present disclosure is not limited thereto.

The distance detecting module 11 of the reversing image display device 10 detects the vehicle reversing distance from the vehicle to the obstruction and determines whether the vehicle reversing distance is higher than a preset distance, wherein the preset distance is, for example, 1.2 m, 1 m and so on; however, the example is merely for exemplary illustration, and the application field of the present disclosure not limited thereto. The preset distance may be set in the reversing image display device 10 in advance or set by a user, and the reversing image display device 10 provides an input function, such as an interface, for the user to edit and modify the preset distance.

The image processing module 13 of the reversing image display device 10 receives the reversing image from the image capture module 12 of the reversing image display device 10, and the image processing module 13 performs image fisheye correction, image cropping processing, image white balance processing and image exposure processing on the reversing image to generate a horizontal-view reversing image. The horizontal-view reversing image has a second image viewing angle range 122, for example, in a range of from −60 degrees to 60 degrees. The second image viewing angle range 122 may be adjusted upon practice demand. FIG. 3B is a schematic view of the second image viewing angle range of the horizontal-view reversing image of the image viewing angle switching system of the present disclosure; however, FIG. 3B is merely for exemplary illustration and the application field of the present disclosure not limited thereto. It is worth noting that the second image viewing angle range 122 is smaller than the first image viewing angle range 121.

The first wireless transmission module 14 of the reversing image display device 10 receives the horizontal-view reversing image from the image processing module 13 of the reversing image display device 10, and then transmits the horizontal-view reversing image to the electronic device 20 by a wireless transmission manner.

The electronic device 20 may be a vehicle mounted device, a handheld device, a smart device and so on; these examples are merely for exemplary illustration and the application field of the present disclosure is not limited thereto. The vehicle mounted device is referred to as a device mounted in the vehicle; the handheld device may be a smartphone, a personal digital assistant (PDA), and so on; the smart device may be a tablet computer, a notebook computer and so on.

The electronic device 20 receives the horizontal-view reversing image from the first wireless transmission module 14 of the reversing image display device 10 by a second wireless transmission module 21 which is embedded or plugged in the electronic device 20. The electronic device 20 displays the horizontal-view reversing image to assist a driver in reversing vehicle.

It is worth noting that the wireless transmission manner used between the first wireless transmission module 14 and the second wireless transmission module 21 is Wi-Fi, Bluetooth, ZigBee and so on; however, these technologies are merely for exemplary illustration and the application field of the present disclosure is not limited thereto. Preferably, the wireless transmission manner used by the first wireless transmission module and the second wireless transmission module may be Wi-Fi, and when a Wi-Fi transmission channel is interfered, the first wireless transmission module 14 and the second wireless transmission module 21 automatically switch the Wi-Fi transmission channel.

When the distance detecting module 11 of the reversing image display device 10 detects and determines that the vehicle reversing distance from the vehicle to the obstruction is smaller than or equal to the preset distance, the distance detecting module 11 transmits a switching command to the image processing module 13 of the reversing image display device 10. The image processing module 13 of the reversing image display device 10 receives the reversing image from the image capture module 12 of the reversing image display device 10, and upon receipt of the switching command from the distance detecting module 11 of the reversing image display device 10, the image processing module 13 performs image fisheye correction, image cropping processing, image white balance processing and image exposure processing on the reversing image to generate a top-view reversing image which has a third image viewing angle range 123. The third image viewing angle range 123 of the top-view reversing image may be adjusted upon practice demand, and for example, in a range of from −90 degrees to 0 degree. FIG. 3C is a schematic view of the third image viewing angle range of the top-view reversing image of the image viewing angle switching system of the present disclosure, but FIG. 3C is merely for exemplary illustration and the application field of the present disclosure is not limited thereto. It is worth noting that the third image viewing angle range 123 is smaller than the first image viewing angle range 121, and the second image viewing angle range 122 and the third image viewing angle range 123 are different from each other.

The first wireless transmission module 14 of the reversing image display device 10 receives the top-view reversing image from the image processing module 13 of the reversing image display device 10, and then transmits the top-view reversing image to the electronic device 20 by the wireless transmission manner. The electronic device 20 receives the top-view reversing image from the first wireless transmission module 14 of the reversing image display device 10 through the second wireless transmission module 21 by the wireless transmission manner. The second wireless transmission module 21 is embedded or plugged in the electronic device 20. As a result, the electronic device 20 is able to display the top-view reversing image, and the scheme of switching from the horizontal-view reversing image to the top-view reversing image may assist the driver in more accurately watching the distance between the vehicle and the obstruction, thereby assisting the driver in reversing the vehicle.

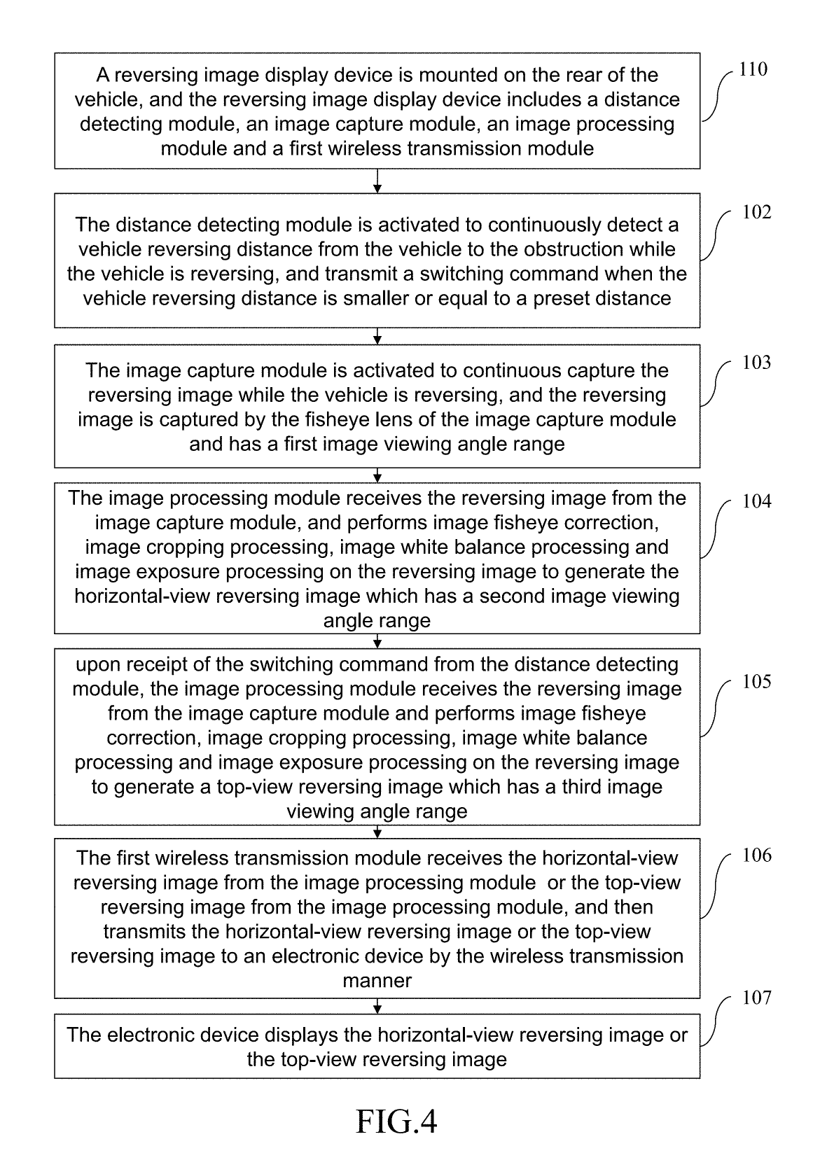

The following refers to FIG. 1 and FIG. 4 to describe an embodiment for illustration of operations of the switching system and method of the present disclosure. FIG. 4 is a flowchart of an image viewing angle switching method for reversing image display, in accordance with the present disclosure.

The reversing image display device 10 is mounted on the rear of the vehicle by screwing through the screw holes 101 at left and right sides of the rear of the vehicle. In a step 110, the reversing image display device 10 includes the distance detecting module 11, the image capture module 12, the image processing module 13 and the first wireless transmission module 14. In a step 102, the distance detecting module 11 of the reversing image display device 10 is activated to continuously detect the vehicle reversing distance from the vehicle to the obstruction while the vehicle is reversing. Preferably, the distance detecting module 11 of the reversing image display device 10 can be implemented by the ultrasonic radar to detect the vehicle reversing distance from the vehicle to the obstruction; however, this example is merely for exemplary illustration, and the application field of the present disclosure is not limited thereto.

In a step 103, the image capture module 12 of the reversing image display device 10 is activated to continuous capture the reversing image while the vehicle is reversing. The reversing image is captured by the fisheye lens of the image capture module 12; in the embodiment, the first image viewing angle range 121 of the reversing image captured by the fisheye lens is in the range of from −90 degrees to 90 degrees. FIG. 3A shows the first image viewing angle range 121 of the reversing image, but it is merely for exemplary illustration and the application field of the present disclosure is not limited thereto.

The distance detecting module 11 of the reversing image display device 10 detects and determines whether the vehicle reversing distance from the vehicle to the obstruction is higher than the preset distance, wherein the preset distance is, for example, 1.2 m, 1 m and so on; but the application field of the present disclosure is not limited thereto. The preset distance can be set in the reversing image display device 10 in advance or set by the user, and the reversing image display device 10 provides the interface for the user to edit or modify the preset distance.

In a step 104, the image processing module 13 of the reversing image display device 10 receives the reversing image from the image capture module 12 of the reversing image display device 10, and the image processing module 13 of the reversing image display device 10 performs image fisheye correction, image cropping processing, image white balance processing and image exposure processing on the reversing image to generate the horizontal-view reversing image 31. In the embodiment, the second image viewing angle range 122 of the horizontal-view reversing image 31 is in the range of from −60 degrees to 60 degree. FIG. 3B is a schematic view of the image viewing angle range of the horizontal-view reversing image of the image viewing angle switching system of the present disclosure and shows the second image viewing angle range 122 of the horizontal-view reversing image 31, but it is merely for exemplary illustration and the application field of the present disclosure is not limited thereto. It is worth noting that the second image viewing angle range 122 is smaller than the first image viewing angle range 121.

Next, in a step 106, the first wireless transmission module 14 of the reversing image display device 10 receives the horizontal-view reversing image 31 from the image processing module 13 of the reversing image display device 10, and then transmits the horizontal-view reversing image 31 to the electronic device 20 by the wireless transmission manner.

The electronic device 20 may be a vehicle mounted device, a handheld device, a smart device and so on; these examples are merely for exemplary illustration and the application field of the present disclosure is not limited thereto. The vehicle mounted device is referred to as a device mounted in the vehicle; the handheld device may be a smartphone, a personal digital assistant (PDA), and so on; the smart device may be a tablet computer, a notebook computer and so on.

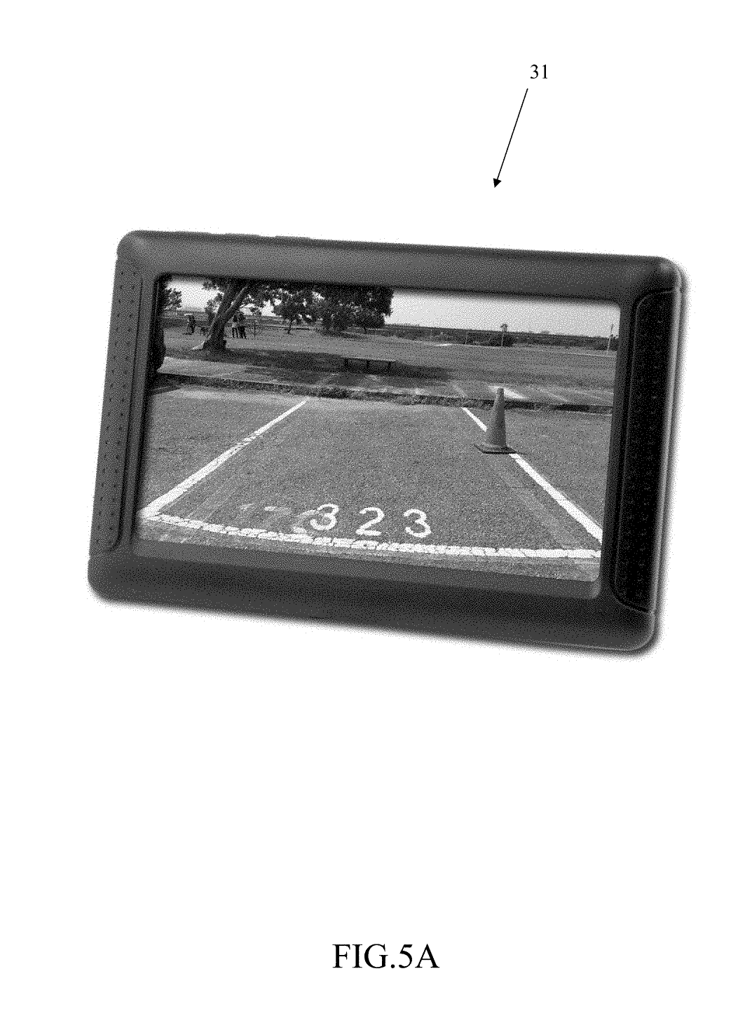

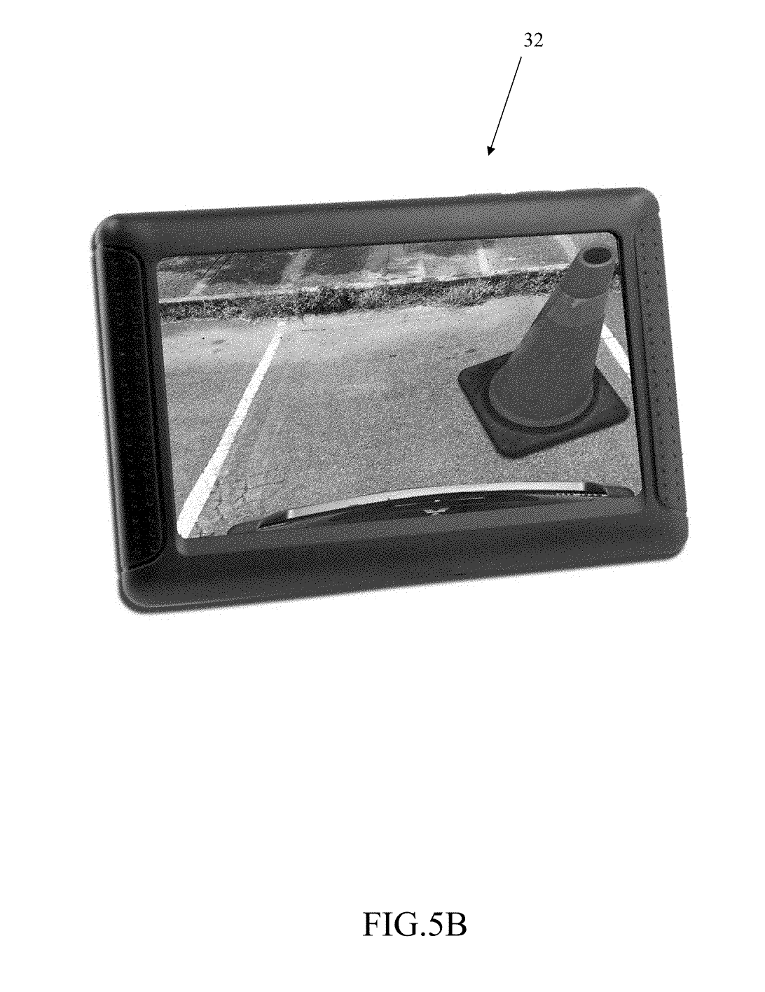

In a step 107, the electronic device 20 receives the horizontal-view reversing image from the first wireless transmission module 14 of the reversing image display device 10 through a second wireless transmission module 21 by the wireless transmission manner, the second wireless transmission module 21 is embedded in the electronic device 20 or plugged in the electronic device 20, so that the electronic device 20 can display the horizontal-view reversing image to assist the driver in reversing vehicle. FIG. 5A shows the horizontal-view reversing image of the image viewing angle switching system of the present disclosure.

It is worth noting that the wireless transmission manner used between the first wireless transmission module 14 and the second wireless transmission module 21 is Wi-Fi, Bluetooth, ZigBee and so on; however, these technologies are merely for exemplary illustration and the application field of the present disclosure is not limited thereto.

In a step 105, when the distance detecting module 11 of the reversing image display device 10 detects and determines that the vehicle reversing distance from the vehicle to the obstruction is smaller than or equal to the preset distance, the distance detecting module 11 transmits a switching command to the image processing module 13 of the reversing image display device 10. The image processing module 13 of the reversing image display device 10 receives the reversing image from the image capture module 12 of the reversing image display device 10, and upon receipt of the switching command from the distance detecting module 11 of the reversing image display device 10, the image processing module 13 performs image fisheye correction, image cropping processing, image white balance processing and image exposure processing on the reversing image to generate the top-view reversing image 32. In the embodiment, the third image viewing angle range 123 of the top-view reversing image 32 is in the range of from −90 degrees to 0 degree. FIG. 3C is a schematic view of the third image viewing angle range of the top-view reversing image of the image viewing angle switching system of the present disclosure, and shows the third image viewing angle range 123 of the top-view reversing image 32; however, it is merely for exemplary illustration and the application field of the present disclosure is not limited thereto. It is worth noting that the third image viewing angle range 123 is smaller than the first image viewing angle range 121, and the second image viewing angle range 122 and the third image viewing angle range 123 are different from each other.

In a step 106, the first wireless transmission module 14 of the reversing image display device 10 receives the top-view reversing image from the image processing module 13 of the reversing image display device 10, and then transmits the top-view reversing image to the electronic device 20 by the wireless transmission manner. In the step 107, the electronic device 20 receives the top-view reversing image from the first wireless transmission module 14 of the reversing image display device 10 through the second wireless transmission module 21, which is embedded or plugged in the electronic device 20, by the wireless transmission manner, so that the electronic device 20 is able to display the top-view reversing image 32, and the scheme of switching from the horizontal-view reversing image to the top-view reversing image may assist the driver in more accurately watching the distance between the vehicle and the obstruction, whereby assist the driver in reversing the vehicle. FIG. 5B is a top-view reversing image of the image viewing angle switching system of the present disclosure, and shows the top-view reversing image 32.

To summarize, the difference between the present disclosure and the conventional technology is that the image viewing angle switching system of the present disclosure performs image fisheye correction, image cropping processing, image white balance processing and image exposure processing on the reversing image to generate the horizontal-view reversing image or the top-view reversing image, and switches between the horizontal-view reversing image and the top-view reversing image according to the vehicle reversing distance from the vehicle to the obstruction, thereby assisting the driver in more safely reversing the vehicle.

Therefore, the image viewing angle switching system of the present disclosure is able to avoid the blind spot for the reversing image, thereby solving the conventional technology problem of the existing reversing image display system having the blind spot that causes unsafety.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. An image viewing angle switching system for reversing image display, comprising:
a reversing image display device, mounted at the rear of a vehicle, and comprising:
a distance detecting module activated to continuously detect a vehicle reversing distance from the vehicle to an obstruction while the vehicle is reversing, and transmit a switching command when the vehicle reversing distance is determined to be smaller than or equal to a preset distance;
an image capture module activated to continuously capture a reversing image while the vehicle is reversing, wherein the reversing image is captured by a fisheye lens of the image capture module and has a first image viewing angle range;
an image processing module configured to receive the switching command from the distance detecting module and receive the reversing image from the image capture module, and perform image fisheye correction, image cropping processing, image white balance processing and image exposure processing on the reversing image to generate a horizontal-view reversing image which has a second image viewing angle range, and wherein upon receipt of the switching command, the image processing module performs image fisheye correction, image cropping processing, image white balance processing and image exposure processing on the reversing image to generate a top-view reversing image which has a third image viewing angle range; and
a first wireless transmission module configured to receive the horizontal-view reversing image from the image processing module or receive the top-view reversing image from the image processing module, and transmit the horizontal-view reversing image or the top-view reversing image by a wireless transmission manner; and
an electronic device configured to receive the horizontal-view reversing image or the top-view reversing image from the first wireless transmission module, and display the horizontal-view reversing image or the top-view reversing image.

2. The image viewing angle switching system according to claim 1, wherein the electronic device receives the horizontal-view reversing image or the top-view reversing image from the first wireless transmission module by a second wireless transmission module which is embedded or plugged in the electronic device.

3. The image viewing angle switching system according to claim 2, wherein the wireless transmission manner used by the first wireless transmission module and the second wireless transmission module is Wi-Fi, Bluetooth or ZigBee.

4. The image viewing angle switching system according to claim 3, wherein the wireless transmission manner used by the first wireless transmission module and the second wireless transmission module is Wi-Fi, and when a Wi-Fi transmission channel is interfered, the first wireless transmission module and the second wireless transmission module automatically switch the Wi-Fi transmission channel.

5. The image viewing angle switching system according to claim 1, wherein the preset distance is set in the reversing image display device in advance or is set in the reversing image display device by a user, and the reversing image display device provides the user to edit and modify the preset distance.

6. An image viewing angle switching method for reversing image display, comprising:
providing a reversing image display device mounted at the rear of a vehicle, wherein the reversing image display device comprises a distance detecting module, an image capture module, an image processing module and a first wireless transmission module;
while the vehicle is reversing, activating the distance detecting module to continuously detect a vehicle reversing distance from the vehicle to an obstruction and then transmit a switching command when the vehicle reversing distance is determined to be smaller than or equal to a preset distance;
while the vehicle is reversing, activating the image capture module to continuously capture a reversing image which is captured by a fisheye lens of the image capture module, wherein the reversing image captured by the fisheye lens has a first image viewing angle range;
receiving the reversing image from the image capture module, and performing image fisheye correction, image cropping processing, image white balance processing and image exposure processing on the reversing image to generate a horizontal-view reversing image which has a second image viewing angle range;
when the image processing module receives the switching command from the distance detecting module, the image processing module receives the reversing image and performs image fisheye correction, image cropping processing, image white balance processing and image exposure processing on the reversing image to generate a top-view reversing image which has a third image viewing angle range;
using the first wireless transmission module to receive the horizontal-view reversing image from the image processing module or the top-view reversing image from the image processing module, and then transmit the horizontal-view reversing image or the top-view reversing image to an electronic device by a wireless transmission manner; and
displaying the horizontal-view reversing image or the top-view reversing image on the electronic device.

7. The image viewing angle switching method according to claim 6, wherein the electronic device receives the horizontal-view reversing image or the top-view reversing image from the first wireless transmission module by a second wireless transmission module which is embedded or plugged in the electronic device.

8. The image viewing angle switching method according to claim 7, wherein the wireless transmission manner used by the first wireless transmission module and the second wireless transmission module is Wi-Fi, Bluetooth or ZigBee.

9. The image viewing angle switching method according to claim 8, wherein the wireless transmission manner used by the first wireless transmission module and the second wireless transmission module is Wi-Fi, and when a Wi-Fi transmission channel is interfered, the first wireless transmission module and the second wireless transmission module automatically switch the Wi-Fi transmission channel.

10. The image viewing angle switching method according to claim 6, wherein the preset distance is set in the reversing image display device in advance or is set in the reversing image display device by a user, and the reversing image display device provides the user to edit and modify the preset distance.
